(19) United States
(12) Patent Application Publication
(10) Pub. No.: US 2026/0213357 A1
(43) Pub. Date: Jul. 23, 2026

(54) BUSBAR FOR BATTERY CONNECTION AND BATTERY STACK MANUFACTURING METHOD

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Kenichi MITANI, Mie (JP)

(21) Appl. No.: 19/141,324

(22) PCT Filed: Dec. 5, 2023
(86) PCT No.: PCT/JP2023/043484

§ 371 Date: Jun. 20, 2025

(30) Foreign Application Priority Data
Dec. 23, 2022 (JP) 2022-206504

(51) Int. Cl. H01M 50/505; H01M 10/04; H01M 50/503; H01M 50/591

(52) U.S. Cl. CPC H01M 50/505; H01M 10/0404; H01M 50/503; H01M 50/591

(57) ABSTRACT

A busbar for battery connection includes a laminated conductor formed by laminating a plurality of conductive bands movably relative to each other entirely in a longitudinal direction, a first insertion hole for connection formed by first through holes respectively provided in the plurality of conductive bands overlapping each other in a first end part in the longitudinal direction of the laminated conductor, the first insertion hole for connection penetrating in a lamination direction of the plurality of conductive bands, and a second insertion hole for connection formed by second through holes respectively provided in the plurality of conductive bands overlapping each other in a second end part in the longitudinal direction of the laminated conductor, the second insertion hole for connection penetrating in the lamination direction of the plurality of conductive bands.

### TECHNICAL FIELD

The present disclosure relates to a busbar for battery connection and a battery stack manufacturing method.

### BACKGROUND

A battery cell, which is a minimum constituent unit of a battery, may be singly used, but a plurality of battery cells are often integrated (assembled) and used as a battery module. Further, a plurality of battery modules are often integrated and used as a battery pack. Furthermore, a plurality of battery packs may be used by being integrated.

Patent Document 1 discloses a busbar for connecting adjacent battery cells in a battery module formed by stacking a plurality of battery cells. The busbar disclosed here is provided with a fragile portion having a relatively small compressive strength. If a compression force is applied in a stacking direction of the battery cells, the fragile portion of the busbar is deformed, whereby a load applied from the busbar to the battery cells is allowed to escape.

### PRIOR ART DOCUMENT

### Patent Document

Patent Document 1: JP 2017-216095 A

### SUMMARY OF THE INVENTION

### Problems to be Solved

There are great many shape and size variations of battery cells, battery modules and battery packs (hereinafter, these are collectively called “batteries”). Further, in the case of integrating a plurality of batteries, the number and layout of the batteries to be integrated vary. Thus, there are countless patterns of connection paths connecting the batteries.

The busbar disclosed in Patent Document 1 is a dedicated product designed to realize a connection path of one pattern. Since such a dedicated busbar has a fixed shape, this busbar cannot be used for another product, i.e. another product having a different pattern of a connection path. In high-mix low-volume production or the like, it may be inefficient to individually design and manufacture such dedicated busbars. Thus, a technique capable of connecting batteries by a versatile busbar, i.e. a versatile technique capable of connecting batteries to correspond to connection paths of various patterns is and has been required.

Accordingly, the present disclosure aims to provide a technique capable of connecting batteries to correspond to connection paths of various patterns.

### Means to Solve the Problem

A busbar for battery connection of the present disclosure is provided with a laminated conductor formed by laminating a plurality of conductive bands movably relative to each other entirely in a longitudinal direction, a first insertion hole for connection formed by first through holes respectively provided in the plurality of conductive bands overlapping each other in a first end part in the longitudinal direction of the laminated conductor, the first insertion hole for connection penetrating in a lamination direction of the plurality of conductive bands, and a second insertion hole for connection formed by second through holes respectively provided in the plurality of conductive bands overlapping each other in a second end part in the longitudinal direction of the laminated conductor, the second insertion hole for connection penetrating in the lamination direction of the plurality of conductive bands, at least one of the plurality of second through holes being a long hole long in the longitudinal direction of the conductive bands.

A battery stack manufacturing method of the present disclosure is provided with a first insertion step of inserting a terminal portion of a first battery through a first insertion hole for connection formed by first through holes respectively provided in a plurality of conductive bands overlapping each other entirely and penetrating in a lamination direction of the plurality of conductive bands in a first end part in a longitudinal direction of a laminated conductor formed by laminating the plurality of conductive bands movably relative to each other entirely in the longitudinal direction, a bending step of bending the laminated conductor at a halfway position in the longitudinal direction with the terminal portion of the first battery inserted through the first insertion hole for connection, and a second insertion step of inserting a terminal portion of a second battery through a second insertion hole for connection formed by second through holes respectively provided in the plurality of conductive bands at least partially overlapping each other and penetrating in the longitudinal direction of the plurality of conductive bands in a second end part in the longitudinal direction of the laminated conductor after the laminated conductor is bent, each of the plurality of first through holes being a round hole, and at least one of the plurality of second through holes being a long hole long in the longitudinal direction of the conductive bands.

### Effect of the Invention

According to the present disclosure, batteries can be connected to correspond to connection paths of various patterns.

### BRIEF DESCRIPTION OF THE DRAWINGS

FIG. 1 is a plan view of a busbar for battery connection according to an embodiment.

FIG. 2 is a side view of the busbar for battery connection.

FIG. 3 is a perspective view schematically showing an example of a battery stack.

FIG. 4 is a diagram showing a battery stack manufacturing method.

FIG. 5 is a plan view illustrating the busbar for battery connection in a bent state of the battery stack.

FIG. 6 is a side view illustrating the busbar for battery connection in the bent state of the battery stack.

FIG. 7 is a plan view of a busbar for battery connection according to a modification.

### DETAILED DESCRIPTION TO EXECUTE THE INVENTION

### Description of Embodiments of Present Disclosure

First, embodiments of the present disclosure are listed and described.

The busbar for battery connection of the present disclosure is as follows.
(1) The busbar for battery connection of the present disclosure is provided with a laminated conductor formed by laminating a plurality of conductive bands movably relative to each other entirely in a longitudinal direction, a first insertion hole for connection formed by first through holes respectively provided in the plurality of conductive bands overlapping each other in a first end part in the longitudinal direction of the laminated conductor, the first insertion hole for connection penetrating in a lamination direction of the plurality of conductive bands, and a second insertion hole for connection formed by second through holes respectively provided in the plurality of conductive bands overlapping each other in a second end part in the longitudinal direction of the laminated conductor, the second insertion hole for connection penetrating in the lamination direction of the plurality of conductive bands, at least one of the plurality of second through holes being a long hole long in the longitudinal direction of the conductive bands.

This busbar for battery connection is provided with the laminated conductor in which the plurality of conductive bands are laminated movably relative to each other entirely in the longitudinal direction. Such a laminated conductor is more easily bent than a conductor formed by one metal plate having the same thickness as the laminated conductor, a conductor in which conductive bands adjacent in a lamination direction are fixed not to move relative to each other, and the like. Further, in this busbar for battery connection, at least one of the plurality of second through holes forming the second insertion hole for connection by overlapping each other is a long hole long in the longitudinal direction of the conductive bands. Accordingly, even if path differences occur between the plurality of laminated conductive bands and, thus, position deviations in the longitudinal direction occur between the plurality of conductive bands in the second end part by bending the laminated conductor in a thickness direction, the second insertion hole for connection is easily maintained. As just described, in this busbar for battery connection, the laminated conductor is easily bent and the insertion holes for connection are easily maintained even if the laminated conductor is bent. Therefore, batteries can be connected to correspond to connection paths of various patterns.
(2) In the busbar for battery connection of (1), each of the plurality of first through holes may be a round hole. In this case, the first end part of the laminated conductor can be positioned by inserting a terminal portion of a battery through the first insertion hole for connection formed by the plurality of first through holes, which are respectively round holes, overlapping each other entirely.
(3) In the busbar for battery connection of (1) or (2), the laminated conductor may be bent at a halfway position in the longitudinal direction. In this case, connection paths other than linear ones can be dealt with.
(4) In the busbar for battery connection of (3), the plurality of first through holes may overlap each other entirely, and the plurality of second through holes may at least partially overlap each other while being at positions deviated from each other in the longitudinal direction of the conductive bands. In this case, since the plurality of first through holes overlap each other entirely even if the laminated conductor is bent, the shapes of the first through holes need not be specified, assuming that the plurality of first through holes are arranged at positions deviated from each other in the longitudinal direction. Therefore, the shapes of the first through holes have a high degree of freedom.
(5) The busbar for battery connection of any one of (1) to (4) may be further provided with an insulation coating for collectively covering the plurality of conductive bands while enabling the plurality of conductive bands to move relative to each other in the longitudinal direction. In this case, since the plurality of laminated conductive bands are lumped by the insulation coating, handling is easy. Further, parts of the plurality of laminated conductive bands covered by the insulation coating can be protected while being insulated from the surrounding.
(6) The busbar for battery connection of any one of (1) to (5) may be further provided with an identifier for distinguishing the first end part and the second end part. In this case, a worker or the like who connects batteries using the busbar for battery connection can easily distinguish the first and second end parts of the laminated conductor. Therefore, the worker or the like can easily determine which is a side where the second insertion hole for connection is formed by the plurality of second through holes, at least one of which is a long hole, overlapping each other, i.e. a side where position deviations in the longitudinal direction between the plurality of conductive bands are allowed.

The battery stack manufacturing method of the present disclosure is as follows.
(7) The battery stack manufacturing method of the present disclosure is provided with a first insertion step of inserting a terminal portion of a first battery through a first insertion hole for connection formed by first through holes respectively provided in a plurality of conductive bands overlapping each other entirely and penetrating in a lamination direction of the plurality of conductive bands in a first end part in a longitudinal direction of a laminated conductor formed by laminating the plurality of conductive bands movably relative to each other entirely in the longitudinal direction, a bending step of bending the laminated conductor at a halfway position in the longitudinal direction with the terminal portion of the first battery inserted through the first insertion hole for connection, and a second insertion step of inserting a terminal portion of a second battery through a second insertion hole for connection formed by second through holes respectively provided in the plurality of conductive bands at least partially overlapping each other and penetrating in the longitudinal direction of the plurality of conductive bands in a second end part in the longitudinal direction of the laminated conductor after the laminated conductor is bent, each of the plurality of first through holes being a round hole, and at least one of the plurality of second through holes being a long hole long in the longitudinal direction of the conductive bands.

For example, if path differences occur between the plurality of laminated conductive bands by bending the laminated conductor in a thickness direction, position deviations in the longitudinal direction occur between the plurality of conductive bands in one or both end parts in the longitudinal direction of the laminated conductor. In the above battery stack manufacturing method, the laminated conductor is bent with the terminal portion of the battery inserted through the first insertion hole for connection formed by the plurality of first through holes, which are respectively round holes, overlapping each other entirely, i.e. with the first end part positioned. Accordingly, the position deviations in the longitudinal direction between the plurality of conductive bands appear only on the side of the second end part without appearing on the side of the first end part. In this second end part, at least one of the plurality of second through holes forming the second insertion hole for connection by overlapping each other is a long hole long in the longitudinal direction of the conductive bands. Thus, even if position deviations in the longitudinal direction occur between the plurality of conductive bands in the second end part, the second insertion hole for connection is easily maintained. If the second insertion hole for connection is maintained, the terminal portion is easily inserted therethrough without any difficulty. As just described, in this battery stack manufacturing method, a state where the laminated conductor is bent and the terminal portion is inserted through each of the first and second insertion holes for connection is formed without any difficulty. Therefore, batteries can be connected to correspond to connection paths of various patterns.

### Details of Embodiment of Present Disclosure

Specific examples of a busbar for battery connection and a battery stack manufacturing method of the present disclosure are described below with reference to the drawings. Note that the present disclosure is not limited to these illustrations, but is represented by claims and intended to include all changes in the scope of claims and in the meaning and scope of equivalents.

### Embodiment

### Busbar for Battery Connection

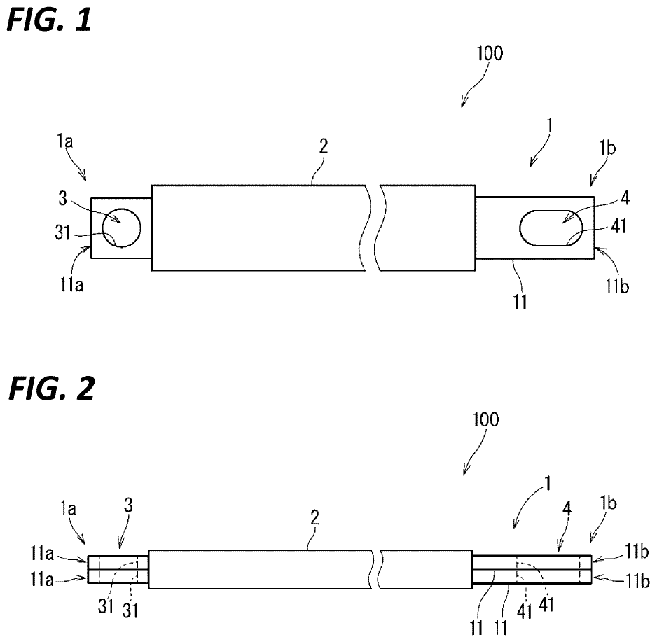

A busbar 100 for battery connection according to an embodiment is described with reference to FIGS. 1 and 2. FIG. 1 is a plan view of the busbar 100 for battery connection. FIG. 2 is a side view of the busbar 100 for battery connection.

The busbar 100 for battery connection is a component for electrically connecting batteries and is one type of a wiring component. The “batteries” to be connected by the busbar 100 for battery connection may be battery cells, battery modules or battery packs.

The busbar 100 for battery connection is provided with a laminated conductor 1, an insulation coating 2 covering the laminated conductor 1, a first insertion hole 3 for connection provided in a first end part 1a of the laminated conductor 1 and a second insertion hole 4 for connection provided in a second end part 1b of the laminated conductor 1.

### Laminated Conductor 1

The laminated conductor 1 includes a plurality of conductive bands 11. Each conductive band 11 is formed of an electrically conductive material. A metal such as copper, copper alloy, aluminum or aluminum alloy can be, for example, adopted as a formation material of the conductive band 11.

Each conductive band 11 is in the form of an elongated band extending while having a constant width and also in the form of a plate having a constant thickness. The plurality of conductive bands 11 are laminated in a thickness direction. The conductive bands 11 adjacent in a lamination direction are at least partially in contact with each other in a longitudinal direction and electrically connected. Further, the plurality of conductive bands 11 are laminated movably relative to each other entirely in the longitudinal direction. That is, the conductive bands 11 adjacent in the lamination direction are not fixed to each other. Therefore, the conductive bands 11 adjacent in the lamination direction can relatively move in the longitudinal direction while rubbing against each other. Thus, the laminated conductor 1 can be easily bent in the thickness direction at an arbitrary position in the longitudinal direction. That is, the laminated conductor 1 is more easily bent than a conductor formed by one metal plate having the same thickness as the laminated conductor 1, a conductor in which conductive bands adjacent in a lamination direction are fixed to each other so as not to move relative to each other, and the like.

The number of the conductive bands 11 to be laminated, a thickness of each of the conductive bands 11 to be laminated, the shape of each of the conductive bands 11 to be laminated and the like can be arbitrarily specified, for example, according to an allowable current value, ease of deformation, processability and the like required for the laminated conductor 1. For example, the number of the conductive bands 11 to be laminated may be any number equal to or greater than two and, for example, ten or more. Further, the thickness of each conductive band 11 may be any value if the conductive band 11 can be easily bent in the thickness direction. For example, the thickness of each conductive band 11 may be 1.0 mm or less or 0.1 mm or less. Further, the plurality of conductive bands 11 to be laminated may have the same thickness or may have different thicknesses. Further, end parts of each conductive band 11 may be shaped to have angular corners or round corners.

### Insulation Coating 2

The insulation coating 2 is a coating for covering the laminated conductor 1. The insulation coating 2 is made of an insulating material, e.g. an insulating resin material. Polyethylene, polyvinyl chloride, silicone rubber and the like can be, for example, adopted as the formation material of the insulation coating 2. The insulation coating 2 covers the laminated conductor 1 substantially entirely in the longitudinal direction. However, end parts 1a, 1b in the longitudinal direction of the laminated conductor 1 are connection ends to be connected to the batteries and exposed from the insulation coating 2. That is, the insulation coating 2 covers the laminated conductor 1 while exposing the respective end parts 1a, 1b in the longitudinal direction of the laminated conductor 1.

As described above, the laminated conductor 1 is provided with the plurality of laminated conductive bands 11, and the insulation coating 2 collectively covers the plurality of laminated conductive bands 11. However, the insulation coating 2 has a sufficiently weak restraining force and does not prevent the plurality of laminated conductive bands 11 from being movable relative to each other entirely in the longitudinal direction. That is, the insulation coating 2 collectively covers the plurality of conductive bands 11 while enabling these conductive bands 11 to move relative to each other in the longitudinal direction. Further, the insulation coating 2 is flexible and does not prevent the plurality of laminated conductive bands 11 from being bent.

### First Insertion Hole 3 for Connection

The first insertion hole 3 for connection is formed in one end part (first end part) 1a in the longitudinal direction of the laminated conductor 1. The first insertion hole 3 for connection is a through hole penetrating through the laminated conductor 1 in the thickness direction, i.e. in the lamination direction of the plurality of conductive bands 11. Specifically, a through hole (first through hole) 31 is provided in each of the plurality of laminated conductive bands 11, and the first insertion hole 3 for connection is formed by the first through holes 31 respectively provided in the plurality of respective conductive bands 11 overlapping each other.

Any of the first through holes 31 provided in the respective conductive bands 11 is a round hole. That is, any of the plurality of respective first through holes 31 forming the first insertion hole 3 for connection by overlapping each other is a round hole. The “round hole” is a hole having a circular shape in a plan view. Further, the plurality of first through holes 31 have the same size and are provided at the same position in the conductive bands 11. Therefore, the plurality of first through holes 31, which are respectively round holes, entirely overlap each other and form the first connection hole 3 for connection, which is a round hole, in a state where there is no position deviation in the longitudinal direction between the plurality of conductive bands 11, i.e. first end edges 11a of the plurality of conductive bands 11 are aligned, in the first end part la.

### Second Insertion Hole 4 for Connection

The second insertion hole 4 for connection is formed in the other end part (second end part) 1b in the longitudinal direction of the laminated conductor 1. Similarly to the first insertion hole 3 for connection, the second insertion hole 4 for connection is a through hole penetrating through the laminated conductor 1 in the thickness direction, i.e. in the lamination direction of the plurality of conductive bands 11. Specifically, a through hole (second through hole) 41 is provided in each of the plurality of laminated conductive bands 11, and the second insertion hole 4 for connection is formed by the second through holes 41 provided in the plurality of respective conductive bands 11 overlapping each other.

Any of the second through holes 41 provided in the respective conductive bands 11 is a long hole long in the longitudinal direction of the conductive band 11. That is, any of the plurality of respective second through holes 41 forming the second insertion hole 4 for connection by overlapping each other is a long hole. The “long hole” is a hole having a length in a certain direction longer than a length in a direction orthogonal to the former direction in a plan view. For example, the long hole is a hole having an oval shape (shape formed by connecting semicircular arcs by straight lines). Further, the plurality of second through holes 41 have the same size and are provided at the same position in the conductive bands 11. Therefore, the plurality of second through holes 41, which are respectively long holes, entirely overlap each other and form the second connection hole 4 for connection, which is a long hole, in a state where there is no position deviation in the longitudinal direction between the plurality of conductive bands 11, i.e. second end edges 11b of the plurality of conductive bands 11 are aligned, in the second end part 1b.

### Manufacturing Method of Busbar for Battery Connection

In manufacturing the busbar 100 for battery connection, the plurality of conductive bands 11 are first prepared and laminated movably relative to each other entirely in the longitudinal direction. In this way, the laminated conductor 1 is obtained.

Subsequently, the insulation coating 2 covering the laminated conductor 1 entirely in the longitudinal direction is formed. The insulation coating 2 is, for example, formed by extruding a softened and melted resin material to cover around the laminated conductor 1. Subsequently, the laminated conductor 1 covered with the insulation coating 2 entirely in the longitudinal direction is cut to a predetermined dimension after a longitudinal dimension is measured. Thereafter, parts of the insulation coating 2 covering the respective end parts la, 1b of the laminated conductor 1 cut to the predetermined dimension are stripped.

After or before the stripping of the part of the insulation coating 2 covering the first end part 1a, press working, specifically hole punching, is applied to the first end part la of the laminated conductor 1 to form the first insertion hole 3 for connection. That is, hole punching is applied collectively to the plurality of laminated conductive bands 11 in the first end part 1a to form the first through holes 31 in the respective conductive bands 11. A circular hole punching die is used in hole-punching the first end part la. Further, the first end part 1a is hole-punched with the first end edges 11a of the plurality of conductive bands 11 aligned. In this way, the first through holes 31, which are round holes having the same size, are formed at the same position near the first end edges 11a of the respective conductive bands 11a.

Similarly, after or before the stripping of the part of the insulation coating 2 covering the second end part 1b, press working, specifically hole punching, is applied to the second end part 1b of the laminated conductor 1 to form the second insertion hole 4 for connection. That is, hole punching is applied collectively to the plurality of laminated conductive bands 11 in the second end part 1b to form the second through holes 41 in the respective conductive bands 11. An oval hole punching die is used in hole-punching the second end part 1b, and a long direction of the oval hole punching die is matched with the longitudinal direction of the conductive bands 11. Further, the second end part 1b is hole-punched with the second end edges 11b of the plurality of conductive bands 11 aligned. In this way, the second through holes 41, which are long holes having the same size, are formed at the same position near the second end edges 11b of the respective conductive bands 11b.

### Battery Stack Manufacturing Method

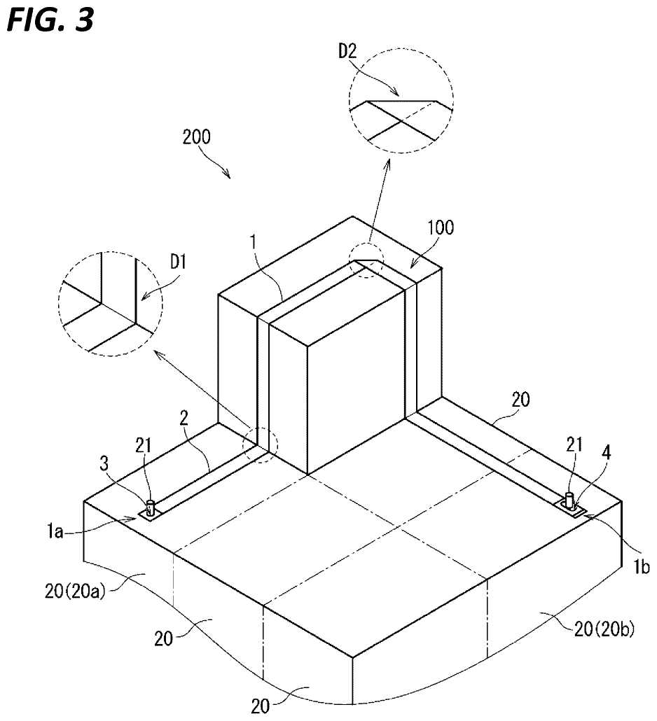

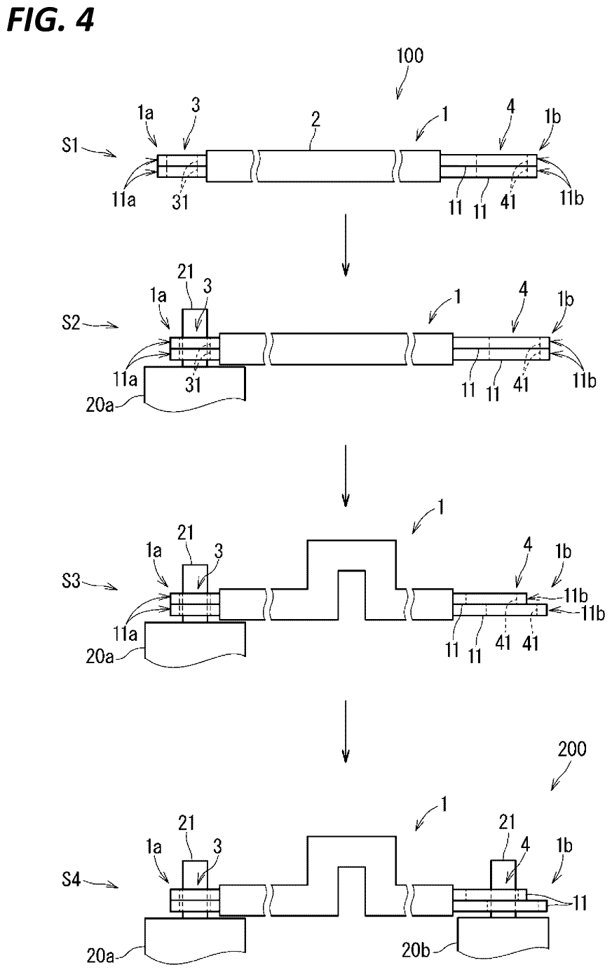

Next, a battery stack 200 and a manufacturing method thereof are described with reference to FIGS. 3 and 4. FIG. 3 is a perspective view schematically showing an example of the battery stack 200. FIG. 4 is a diagram showing the manufacturing method of the battery stack 200.

The battery stack 200 is provided with a group of batteries 20 arranged in a predetermined layout and the busbar 100 for battery connection for electrically connecting two batteries 20 (first battery 20a and second battery 20b), out of the group of the batteries 20. As described above, the batteries 20 connected by the busbar 100 for battery connection may be battery cells, battery modules or battery packs. That is, the battery stack 200 may be a battery module in which battery cells are connected by the busbar 100 for battery connection, may be a battery pack in which battery modules are connected by the busbar 100 for battery connection or may be an assembly in which battery packs are connected by the busbar 100 for battery connection.

### Preparation Step S1

In manufacturing the battery stack 200, the busbar 100 for battery connection is prepared. In this stage, the laminated conductor 1 linearly extends in the longitudinal direction as shown in FIGS. 1 and 2. In this state, the first end edges 11a of the plurality of conductive bands 11 are aligned in the first end part 1a of the laminated conductor 1, and the plurality of first through holes 31, which are respectively round holes, entirely overlap each other to form the first insertion hole 3 for connection, which is a round hole. Further, the second end edges 11b of the plurality of conductive bands 11 are aligned also in the second end part 1b of the laminated conductor 1, and the plurality of second through holes 41, which are respectively long holes, entirely overlap each other to form the second insertion hole 4 for connection, which is a long hole.

### First Insertion Step S2

Subsequently, a terminal portion 21 of the first battery 20a is inserted through the first insertion hole 3 for connection. The terminal portion 21 is a cylindrical conductive member provided on the battery 20 and connected to a positive or negative electrode of the battery 20. The terminal portion 21 is also called a terminal, an outer terminal or the like. For example, the terminal portion 21 is a stud bolt standing from one surface of the battery 20, but there is no limitation to this. By inserting the terminal portion 21 through the first insertion hole 3 for connection formed by the plurality of first through holes 31, which are respective round holes, overlapping each other entirely, the first end part 1a of the laminated conductor 1 is positioned with the first end edges 11a of the plurality of laminated conductive bands 11 aligned.

After the terminal portion 21 of the first battery 20a is inserted through the first insertion hole 3 for connection, a nut (not shown) serving as a fastening member is inserted onto the terminal portion 21 and screwed and fastened. In this way, the first end part 1a, which is a connection end, and the terminal portion 21 of the first battery 20a are fixed while being electrically connected.

### Bending Step S3

Subsequently, the laminated conductor 1 is bent at a halfway position in the longitudinal direction with the terminal portion 21 of the first battery 20a inserted through the first insertion hole 3 for connection. That is, by bending the laminated conductor 1 in an appropriate direction at an appropriate position, the laminated conductor 1 is deformed into a shape corresponding to a necessary connection path, i.e. a connection path connecting the terminal portion 21 of the first battery 20a and a terminal portion 21 of the second battery 20b. As described above, the laminated conductor 1 is configured by laminating the plurality of conductive bands 11 thinner than the thickness thereof. Further, in the laminated conductor 1, the plurality of conductive bands 11 are laminated movably relative to each other entirely in the longitudinal direction. Thus, the laminated conductor 1 can be easily bent.

The laminated conductor 1 may be bent into any form. For example, the laminated conductor 1 may be bent in the thickness direction, i.e. the lamination direction of the conductive bands 11. Bending in the thickness direction means bending to change the thickness direction. For example, a bent part D1 L-shaped in a side view may be formed by bending the laminated conductor 1 at 90° in the thickness direction at a fold line orthogonal to the longitudinal direction. In this case, the thickness direction is changed by 90°. Further, for example, a bent part D2 L-shaped in a plan view may be formed by bending the laminated conductor 1 by 180° in the thickness direction at a fold line at 45° to the longitudinal direction. In this case, the thickness direction is changed by 180°. Further, for example, a bent part U-shaped in a plan view may be formed by bending the laminated conductor 1 by 180° while forming an arc at a halfway position in the longitudinal direction. Also in this case, the thickness direction is changed by 180°. Further, for example, the laminated conductor 1 may be bent to be twisted. That is, the laminated conductor 1 may be rotated about an axis along the longitudinal direction. For example, if the lamination direction 1 is rotated by 90° about the axis along the longitudinal direction, the thickness is changed by 90°.

If the laminated conductor 1 is bent in the thickness direction, path differences occur between the plurality of laminated conductive bands 11. If the path differences occur (more precisely, if the sum of the path differences occurring in the respective bent parts at one or more positions formed in the laminated conductor 1 does not become zero), position deviations in the longitudinal direction occur between the plurality of conductive bands 11 in one or both of the end parts 1a, 1b in the longitudinal direction of the laminated conductor 1. However, the laminated conductor 1 is bent with the terminal portion 21 of the first battery 20a inserted through the first insertion hole 3 for connection, i.e. with the first end part 1a positioned. In this case, the position deviations in the longitudinal direction between the plurality of conductive bands 11 appear only on the side of the second end part 1b without appearing on the side of the first end part 1a. That is, the first end edges 11a of the respective conductive bands 11 are kept aligned, and the second end edges 11b of the respective conductive bands 11 are arranged at positions deviated from each other.

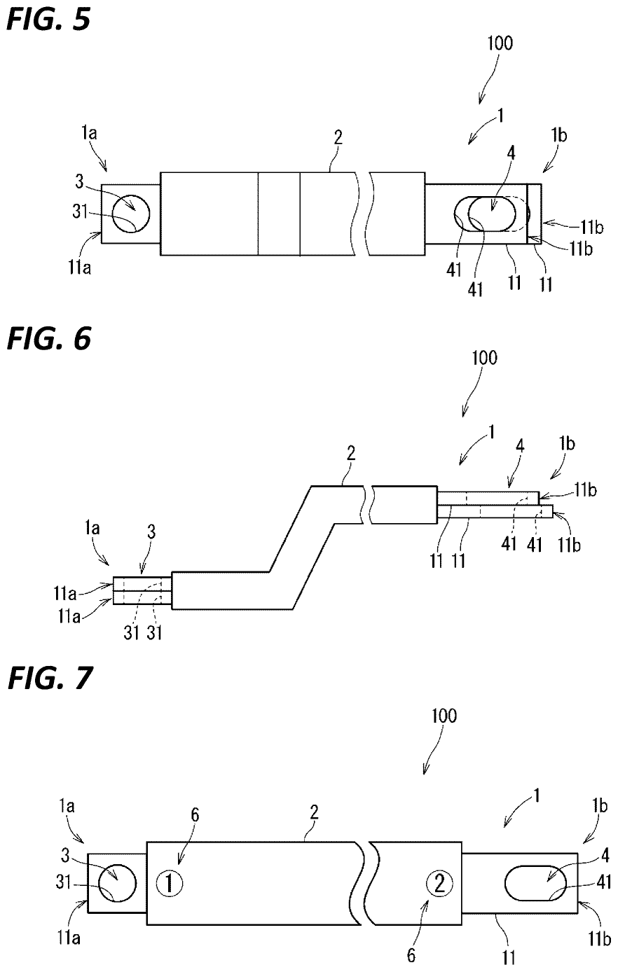

FIGS. 5 and 6 illustrate the busbar 100 for battery connection when the laminated conductor 1 is bent with the first end part 1a positioned.

As described above, if the laminated conductor 1 is bent with the first end part la positioned, position deviations in the longitudinal direction do not occur between the plurality of conductive bands 11 in the first end part 1a even if the path differences occur between the plurality of conductive bands 11. Therefore, a state where the plurality of first through holes 31 overlap each other entirely to form the first insertion hole 3 for connection is maintained in the first end part 1a.

On the other hand, if the laminated conductor 1 is bent with the first end part 1a positioned, position deviations in the longitudinal direction occur between the plurality of conductive bands 11 in the second end part 1b if path differences occur between the plurality of conductive bands 11. Here, the second through holes 41 are long holes long in the longitudinal direction of the conductive bands 11. Accordingly, even if the plurality of second through holes 41 are arranged at the positions deviated from each other in the longitudinal direction of the conductive bands 11 due to the position deviations in the longitudinal direction between the plurality of conductive bands 11 in the second end part 1b, the plurality of second through holes 41 partially overlap each other, whereby there is a high possibility that the second insertion hole 4 for connection is maintained. Here, that “the second insertion hole 4 for connection is maintained” means that the second insertion hole 4 for connection maintains a function as an insertion hole for connection, through which the terminal portion 21 or the like to be connected is inserted. For example, if a dimension in the longitudinal direction of the second insertion hole 4 for connection formed by the plurality of second through holes 41 overlapping each other is larger than an outer diameter of the terminal portion 21 to be connected, it can be said that the second insertion hole 4 for connection is maintained.

### Second Insertion Step S4

If the laminated conductor 1 is bent and deformed into a shape corresponding to the necessary connection path, the terminal portion 21 of the second battery 20b is subsequently inserted through the second insertion hole 4 for connection. As described above, if the path differences occur between the plurality of conductive bands 11 by bending the laminated conductor 1 in the thickness direction, the position deviations in the longitudinal direction occur between the plurality of conductive bands 11 in the second end part 1b. Even in such a case, the plurality of second through holes 41 partially overlap each other while being at positions deviated from each other in the longitudinal direction of the conductive bands 11, whereby there is a high possibility that the second insertion hole 4 for connection is maintained. If the second insertion hole 4 for connection is maintained, the terminal portion 21 is inserted through the second insertion hole 4 for connection without any difficulty.

Particularly, if the path differences occurring between the plurality of conductive bands 11 are relatively small, there is a high possibility that the second insertion hole 4 for connection formed by the plurality of second through holes 41 partially overlapping each other is shorter than the individual second through holes 41, but remains as a long hole long in the longitudinal direction of the conductive bands 11. If the second insertion hole 4 for connection is maintained as a long hole, an extra working length equivalent to a length of that long hole is ensured, wherefore the terminal portion 21 is easily inserted through the second insertion hole 4 for connection.

After the terminal portion 21 of the second battery 20b is inserted through the second insertion hole 4 for connection, a nut (not shown) serving as a fastening member is inserted onto the terminal portion 21 and screwed and fastened. In this way, the second end part 1b, which is a connection end, and the terminal portion 21 of the second battery 20b are fixed while being electrically connected.

In the above way, the first and second batteries 20a, 20b are electrically connected by the busbar 100 for battery connection and the battery stack 200 is obtained.

### Effects, Etc.

The busbar 100 for battery connection configured as described above is provided with the laminated conductor 1 in which the plurality of conductive bands 11 are laminated movably relative to each other entirely in the longitudinal direction. Such a laminated conductor 1 is, for example, more easily bent than a conductor formed by one metal plate having the same thickness as the laminated conductor 1, a conductor in which conductive bands adjacent in a lamination direction are fixed not to move relative to each other, and the like. Further, in the busbar 100 for battery connection, at least one of the plurality of second through holes 41 forming the second insertion hole 4 for connection by overlapping each other is a long hole long in the longitudinal direction of the conductive bands 11. Accordingly, the second insertion hole 4 for connection is easily maintained even if path differences occur between the plurality of laminated conductive bands 11 by bending the laminated conductor 1 in the thickness direction and, therefore, the position deviations in the longitudinal direction occur between the plurality of conductive bands 11 in the second end part 1b. As just described, in the busbar 100 for battery connection, the laminated conductor 1 is easily bent and the second insertion hole 4 for connection is easily maintained even if the laminated conductor 1 is bent. Therefore, the batteries 20 can be connected in connection paths of various patterns by deforming the laminated conductor 1 into shapes corresponding to the connection paths of various patterns. That is, the batteries 20 can be connected to correspond to the connection paths of various patterns.

For example, the battery stacks 200 used in a vehicle, a truck, a train, a house, an infrastructure equipment and the like often high-mix low-volume products. Therefore, if the busbar 100 for battery connection is used to connect the batteries 20 (typically, for example, to connect battery modules) in the battery stack 200 used in these fields, development man-hours and manufacturing cost can be effectively reduced, for example, as compared to the case where a dedicatedly designed busbar is used.

Further, in the busbar 100 for battery connection, each of the plurality of second through holes 41 is a long hole. In this case, a maximum position deviation amount in the longitudinal direction allowed between the plurality of conductive bands 11, i.e. a maximum position deviation amount capable of maintaining the second insertion hole 4 for connection, is larger, for example, as compared to the case where round holes and long holes are mixed as the plurality of second through holes 41. That is, the second insertion hole 4 for connection is more easily maintained. Further, if each of the plurality of second through holes 41 is a long hole, the second insertion hole 4 for connection can be maintained as a long hole even if the position deviations in the longitudinal direction occur between the plurality of conductive bands 11. If the second insertion hole 4 for connection is maintained as a long hole, the terminal portion 21 is easily inserted through the second insertion hole 4 for connection.

Further, in the busbar 100 for battery connection, each of the plurality of first through holes 31 is a round hole. In this case, the first end part 1a of the laminated conductor 1 can be positioned by inserting the terminal portion 21 of the battery 20 or the like through the first insertion hole 3 for connection formed by the plurality of first through holes 31, which are respectively round holes, overlapping each other entirely.

Processing cost for forming the round holes is lower than that for forming the long holes. Therefore, the busbar 100 for battery connection in which each of the plurality of first through holes 31 is a round hole and each of the plurality of second through holes 41 is a long hole can be, for example, manufactured at lower cost than a busbar for battery connection in which each of the plurality of first through holes 31 is a long hole and each of the plurality of second through holes 41 is also a long hole.

Further, the battery 100 for battery connection can deal with connection paths other than linear ones if the laminated conductor 1 is bent at a halfway position in the longitudinal direction. Further, if the plurality of first through holes 31 are entirely maintained in a state overlapping each other when the laminated conductor 1 is bent, the shapes of the first through holes 31 need not be specified, assuming that the plurality of first through holes 31 are arranged at positions deviated from each other in the longitudinal direction. The first through holes 31 need not be formed into long holes, for example, assuming that the plurality of first through holes 31 are arranged at positions deviated from each other in the longitudinal direction. For example, the first through holes 31 can be round holes, which can be formed at lower cost than long holes.

Further, the busbar 100 for battery connection is provided with the insulation coating 2 for collectively covering the plurality of conductive bands 11 while enabling these conductive bands 11 to move relative to each other in the longitudinal direction. In this case, since the plurality of laminated conductive bands 11 are collectively lumped by the insulation coating 2, handling is easy. Further, parts of the plurality of laminated conductive bands 11 covered by the insulation coating 2 can be protected while being insulated from the surrounding.

Further, in the above manufacturing method of the battery stack 200, the laminated conductor 1 is bent with the terminal portion 21 of the battery 20 inserted through the first insertion hole 3 for connection formed by the plurality of first insertion holes 31, which are respectively round holes, overlapping each other entirely, i.e. with the first end part 1a positioned. Accordingly, the position deviations in the longitudinal direction between the plurality of conductive bands 11 appear only on the side of the second end part 1b without appearing on the side of the first end part 1a. In this second end part 1b, at least one of the plurality of second through holes 41 forming the second insertion hole 4 for connection by overlapping each other is a long hole long in the longitudinal direction of the conductive bands 11. Thus, even if the position deviations in the longitudinal direction occur between the plurality of conductive bands 11 in the second end part 1b, the second insertion hole 4 for connection is easily maintained. If the second insertion hole 4 for connection is maintained, the terminal portion 21 is inserted therethrough without any difficulty. As just described, in this manufacturing method of the battery stack 200, the state where the laminated conductor 1 is bent and the terminal portions 21 are inserted through the respective first and second insertion holes 3, 4 for connection is formed without any difficulty. Therefore, the batteries 20 can be connected in connection paths of various patterns by deforming the laminated conductor 1 into shapes corresponding to the connection paths of the various patterns. That is, the batteries 20 can be connected to correspond to the connection paths of the various patterns.

To avoid a situation where the insertion hole for connection is closed due to position deviations in a longitudinal direction between a plurality of conductive bands due to the bending of a laminated conductor in a thickness direction, a measure for forming the insertion hole for connection after the laminated conductor is bent is also thought. That is, after the laminated conductor covered with an insulation coating is measured and cut, the cut laminated conductor is bent and deformed into a shape corresponding to a necessary connection path. Thereafter, i.e. with position deviations in the longitudinal direction occurring between the plurality of conductive bands in one or both end parts in the longitudinal direction, stripping and hole punching are applied to each end of the laminated conductor. However, according to this measure, measurement and cutting, and stripping and hole punching cannot be performed in a row (e.g. in the same production line). Further, if hole punching is performed after the laminated conductor is bent in a battery stack assembly site, a burden on a worker in the assembly site is increased. With the above busbar 100 for battery connection, measurement and cutting, and stripping and hole punching can be performed in a row. Further, since hole punching needs not be performed in the assembly site of the battery stack 200, the burden on the worker in the assembly site is not increased.

### Modifications

The busbar 100 for battery connection according to the above embodiment may be provided with identifiers 6 for distinguishing the first and second end parts 1a, 1b of the laminated conductor 1. Specific forms of the identifiers 6 do not matter. For example, as illustrated in FIG. 7, the identifiers 6 may be provided by printing “1” on an end part of the insulation coating 2 on the side of the first end part 1a and “2” on an end part of the insulation coating 2 on the side of the second end part 1b. Alternatively, the identifier 6 may be provided by printing an explanatory text that “fix this side first” on the end part of the insulation coating 2 on the side of the first end part 1a.

In the case of providing the identifiers 6, a worker or the like who connects the batteries 20 using the busbar 100 for battery connection can easily distinguish the first and second end parts 1a, 1b of the laminated conductor 1. Therefore, the worker or the like can easily determine which is the side where the second insertion hole 4 for connection is formed by the plurality of second through holes 41, at least one of which is a long hole, overlapping each other, i.e. the side where the position deviations in the longitudinal direction between the plurality of conductive bands 11 are allowed.

As described above, in connecting the batteries 20 using the busbar 100 for battery connection, the terminal portion 21 is preferably inserted through the first insertion hole 3 for connection provided in the first end part 1a before the terminal portion 21 is inserted through the second insertion hole 4 for connection provided in the second end part 1b. If the identifiers 6 not only provide identification information for distinguishing the first and second end parts 1a, 1b, but also indicate a preferred insertion order, the worker can proceed with the operation in the preferred insertion order without hesitation.

In the busbar 100 for battery connection according to the above embodiment, each of the plurality of second through holes 41 forming the second insertion hole 4 for connection by overlapping each other is a long hole long in the longitudinal direction of the conductive bands 11. That is, all the plurality of second through holes 41 are long holes. However, out of the plurality of second through holes 41, at least one second through hole 41 may be a long hole long in the longitudinal direction of the conductive bands 11 and the remaining second through holes 41 may be round holes. Even in this configuration, the second insertion hole 4 for connection is easily maintained by the plurality of second through holes 41 at least partially overlapping each other while being at positions deviated from each other in the longitudinal direction of the conductive bands 11 when position deviations in the longitudinal direction occur between the plurality of conductive bands 11 in the second end part 1b. However, if the round and long are mixed as the plurality of second through holes 41, the “the plurality of second through holes 41 are at positions deviated from each other in the longitudinal direction of the conductive bands 11” indicates a state where centers of the respective second through holes 41 are at positions deviated from each other in the longitudinal direction of the conductive bands 11.

In the busbar 100 for battery connection according to the above configuration, each of the plurality of first through holes 31 forming the first insertion hole 3 for connection by overlapping each other is a round hole. That is, all the plurality of first through holes 31 are round holes. However, out of the plurality of first through holes 31, at least one first through hole 31 may be a round hole and the remaining first through holes 31 may be long holes long in the longitudinal direction of the conductive bands 11. Alternatively, all the plurality of first through holes 31 may be long holes. In the case of these configurations, the first insertion hole 3 for connection is easily maintained by the plurality of first through holes 31 at least partially overlapping each other while being at positions deviated from each other in the longitudinal direction of the conductive bands 11 when position deviations in the longitudinal direction occur between the plurality of conductive bands 11 in the first end part 1a. That is, position deviations in the longitudinal direction are allowed not only in the second end part 1b, but also in the first end part 1a.

In the above embodiment, the first and second insertion holes 3, 4 for connection are formed by applying hole punching to the respective end parts 1a, 1b of the laminated conductor 1. However, the first and second insertion holes 3, 4 for connection may be formed, for example, by drilling, processing using a drilling jig or the like, other than hole punching. The first and second insertion holes 3, 4 for connection may be formed simultaneously or successively. In forming the first insertion hole 3 for connection, the plurality of first through holes 31 may not necessarily be collectively formed and may be successively formed. Also in forming the second insertion hole 4 for connection, the plurality of second through holes 41 may not necessarily be collectively formed and may be successively formed.

The busbar 100 for battery connection may be, for example, manufactured as follows. First, the plurality of conductive bands 11 cut to the predetermined dimension in advance are prepared and laminated. In this way, the laminated conductor 1 having the predetermined dimension is obtained. Thereafter, the first and second insertion holes 3, 4 for connection are formed by applying hole punching to the respective end parts 1a, 1b of the laminated conductor 1. After or before the first and second insertion holes 3, 4 for connection are formed, the insulation coating 2 is formed by injection molding using a mold. Specifically, the insulation coating 2 covering the laminated conductor 1 while exposing the respective end parts 1a, 1b is, for example, formed by injecting the softened and melted resin material into the mold having the laminated conductor 1 inserted therein. That is, the insulation coating 2 covering the laminated conductor 1 is formed by insert molding.

Note that the respective configurations described in the above embodiment and each modification can be appropriately combined without contradicting each other.

### LIST OF REFERENCE NUMERALS

1 laminated conductor
1a first end part of laminated conductor
1b second end part of laminated conductor
11 conductive band
11a first end edge of conductive band
11b second end edge of conductive band
2 insulation coating
3 first insertion hole for connection
31 first through hole
4 second insertion hole for connection
41 second through hole
6 identifier
20 battery
20a first battery
20b second battery
21 terminal portion
100 busbar for battery connection
200 battery stack
S1 preparation step
S2 first insertion step
S3 bending step
S4 second insertion step

1. A busbar for battery connection, comprising:
a laminated conductor formed by laminating a plurality of conductive bands movably relative to each other entirely in a longitudinal direction;
a first insertion hole for connection formed by first through holes respectively provided in the plurality of conductive bands overlapping each other in a first end part in the longitudinal direction of the laminated conductor, the first insertion hole for connection penetrating in a lamination direction of the plurality of conductive bands; and
a second insertion hole for connection formed by second through holes respectively provided in the plurality of conductive bands overlapping each other in a second end part in the longitudinal direction of the laminated conductor, the second insertion hole for connection penetrating in the lamination direction of the plurality of conductive bands;
at least one of the plurality of second through holes being a long hole long in the longitudinal direction of the conductive bands.

2. The busbar for battery connection of claim 1, wherein each of the plurality of first through holes is a round hole.

3. The busbar for battery connection of claim 1, wherein the laminated conductor is bent at a halfway position in the longitudinal direction.

4. The busbar for battery connection of claim 3, wherein:
the plurality of first through holes overlap each other entirely, and
the plurality of second through holes at least partially overlap each other while being at positions deviated from each other in the longitudinal direction of the conductive bands.

5. The busbar for battery connection of claim 1, further comprising an insulation coating for collectively covering the plurality of conductive bands while enabling the plurality of conductive bands to move relative to each other in the longitudinal direction.

6. The busbar for battery connection of claim 1, further comprising an identifier for distinguishing the first end part and the second end part.

7. A battery stack manufacturing method, comprising:
a first insertion step of inserting a terminal portion of a first battery through a first insertion hole for connection formed by first through holes respectively provided in a plurality of conductive bands overlapping each other entirely and penetrating in a lamination direction of the plurality of conductive bands in a first end part in a longitudinal direction of a laminated conductor formed by laminating the plurality of conductive bands movably relative to each other entirely in the longitudinal direction,
a bending step of bending the laminated conductor at a halfway position in the longitudinal direction with the terminal portion of the first battery inserted through the first insertion hole for connection; and
a second insertion step of inserting a terminal portion of a second battery through a second insertion hole for connection formed by second through holes respectively provided in the plurality of conductive bands at least partially overlapping each other and penetrating in the longitudinal direction of the plurality of conductive bands in a second end part in the longitudinal direction of the laminated conductor after the laminated conductor is bent,
each of the plurality of first through holes being a round hole, and
at least one of the plurality of second through holes being a long hole long in the longitudinal direction of the conductive bands.
